(19) United States
(12) Patent Application Publication
(10) Pub. No.: US 2013/0041833 A1
(43) Pub. Date: Feb. 14, 2013

(54) PROCESSS OF ELECTRONIC MANAGEMENT OF ORGANIC PRODUCTION AND CERTIFICATION

(71) Applicants: Sitaram Prasad Paikray, New Delhi (IN); C.R Hazra, New Delhi (IN); P Das, Gurgoan (IN)

(72) Inventors: Sitaram Prasad Paikray, New Delhi (IN); C.R Hazra, New Delhi (IN); P Das, Gurgoan (IN)

(73) Assignee: INTERNATIONAL TRACEABILITY SYSTEM LIMITED, New Delhi (IN)

(21) Appl. No.: 13/640,005

(22) PCT Filed: Oct. 4, 2010
(86) PCT No.: PCT/IB2010/054472

§ 371 Date: Oct. 8, 2012

(30) Foreign Application Priority Data
Apr. 9, 2010 (IN) 877/DEL/2010

(51) Int. Cl. G06Q 50/02

(52) U.S. Cl. 705/317

(57) ABSTRACT

The present invention relates to a process of electronic management of organic production including cluster formation of farmers, training of farmers according to organic farming standards, providing organic compliance manual, farm diary, organic bulletin to the farmers, on-farm input management, collection and analysis of soil, providing identity card, soil health card and in ‘in soil culture’, providing NADEP and Cow Pat Pit and demonstrations on on-farm management. Further disclosed is a process of implementation of e-traceability. The information about the day to day activities taken up by all the registered farmers in the fields is collected as per the prescribed format of e-traceability by the cluster in charge on monthly basis and further uploaded in the website. Furthermore provided is a process for setting up an Internal Control System (ICS) for internal inspection of assessment of risk and its management is followed by the approval of decision from an approval committee. This invention relates to a process of external inspection from certification body and finally, certificates are provided to the farmers at the end of each conversion year till the three years.

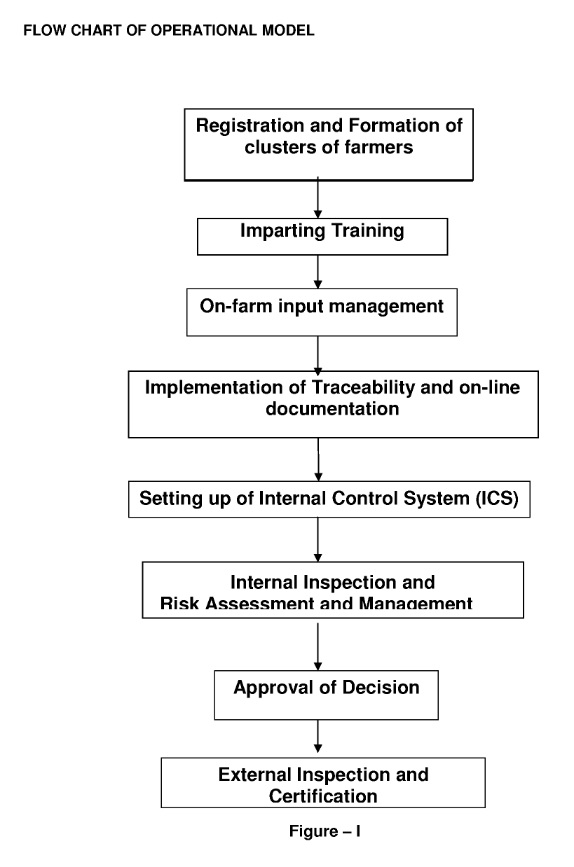

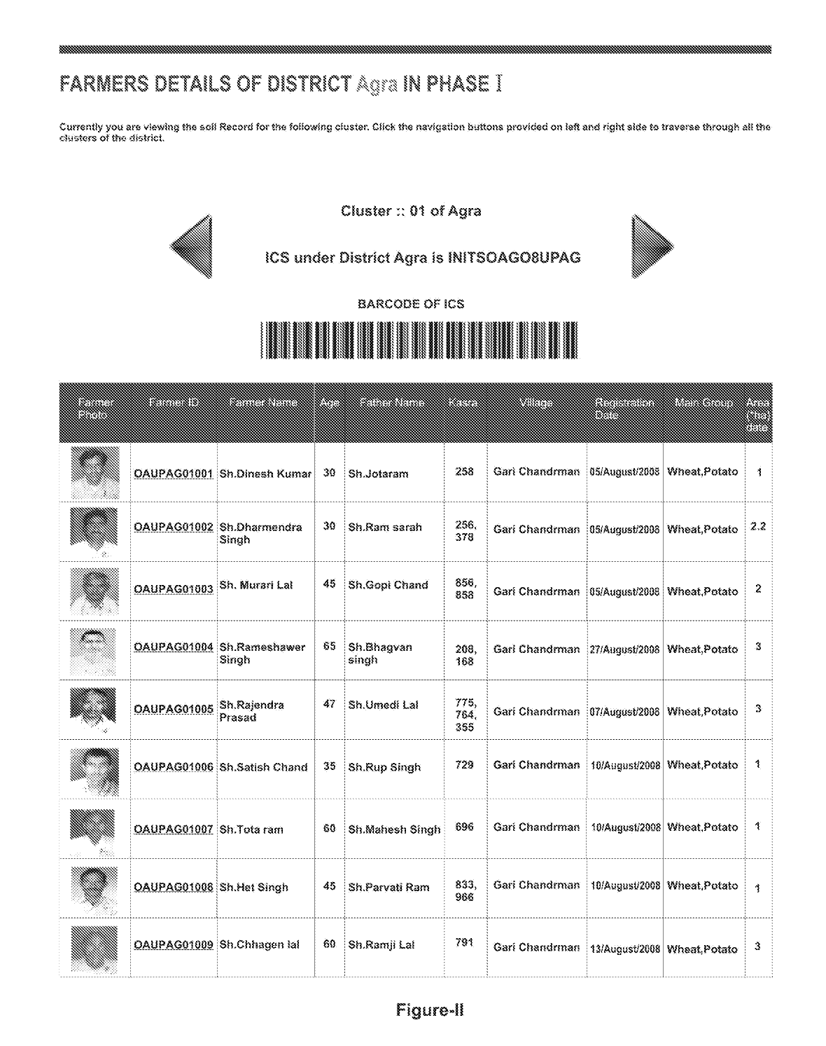

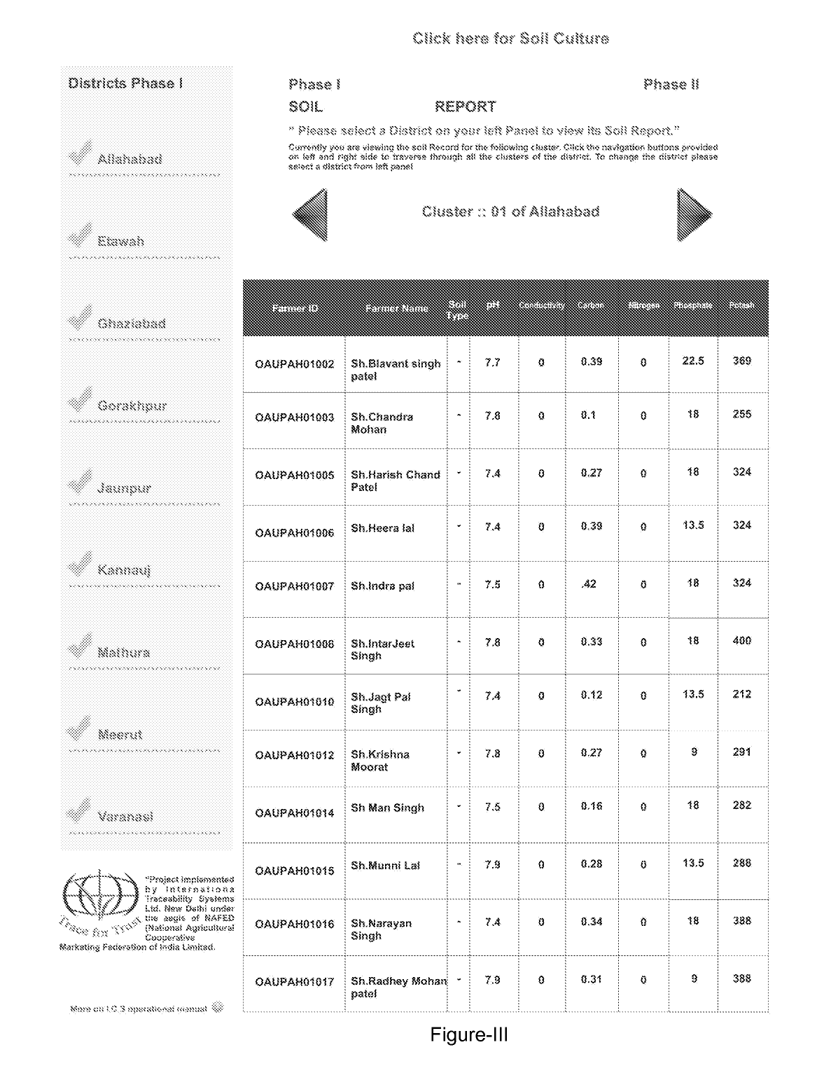

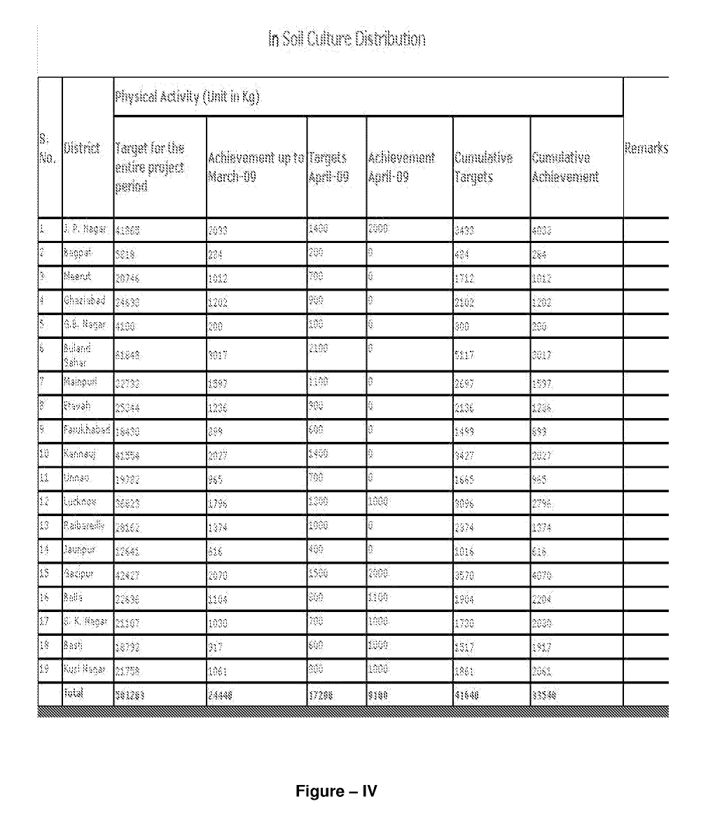

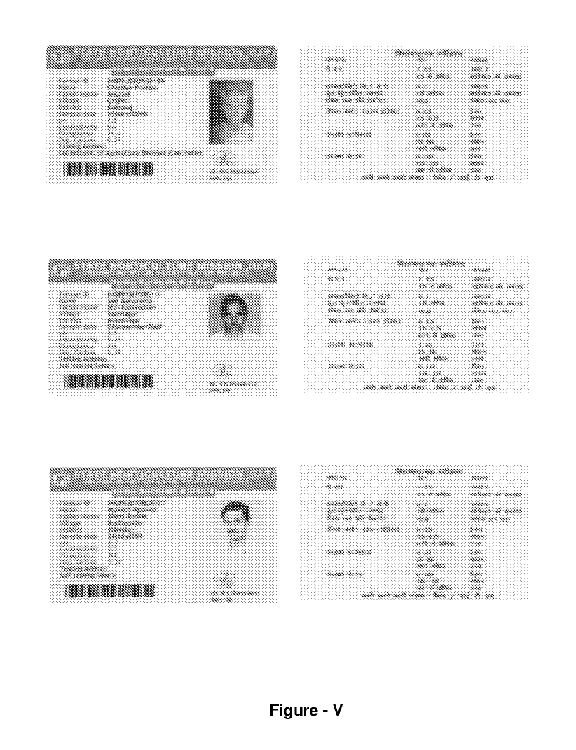

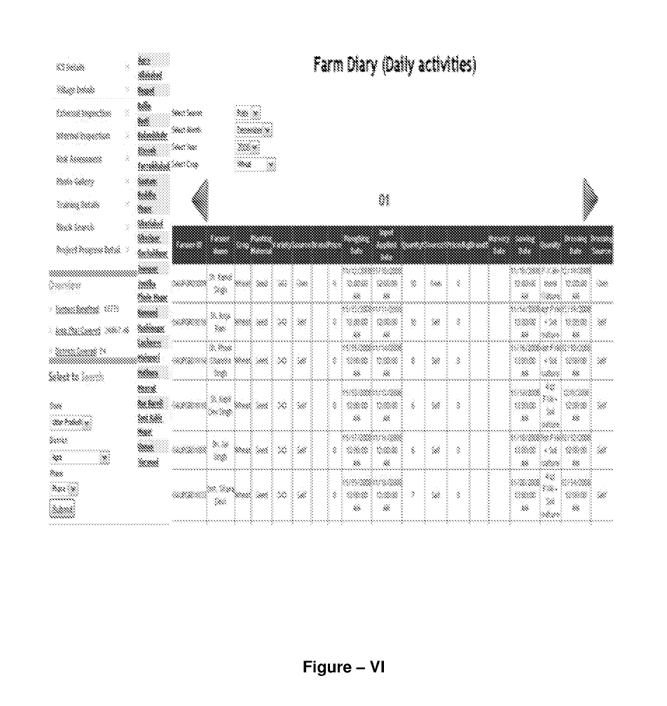

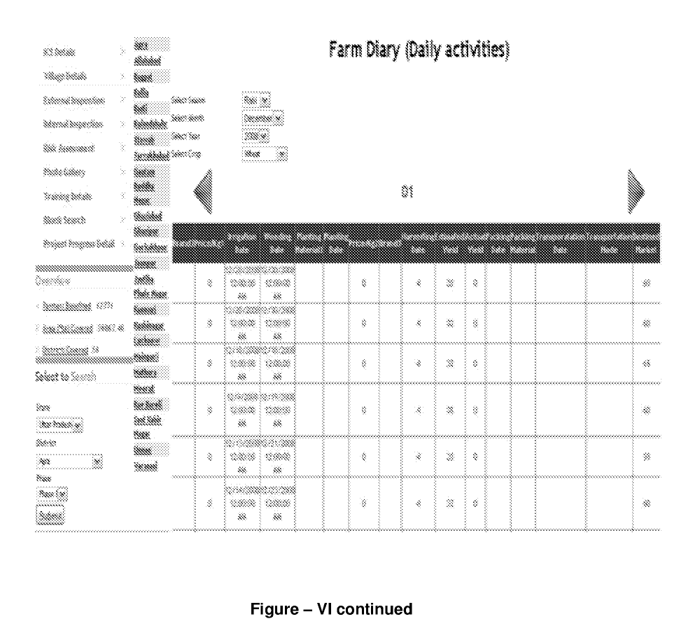

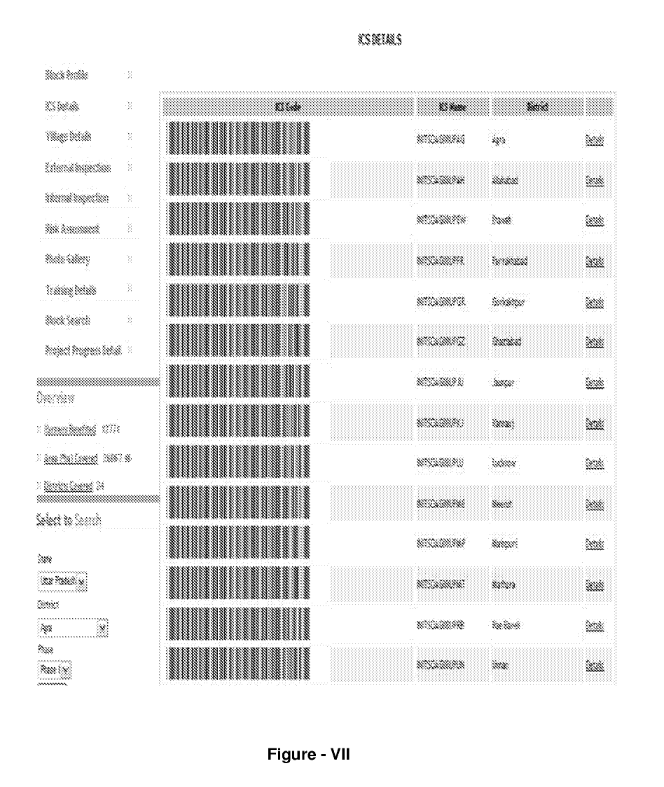

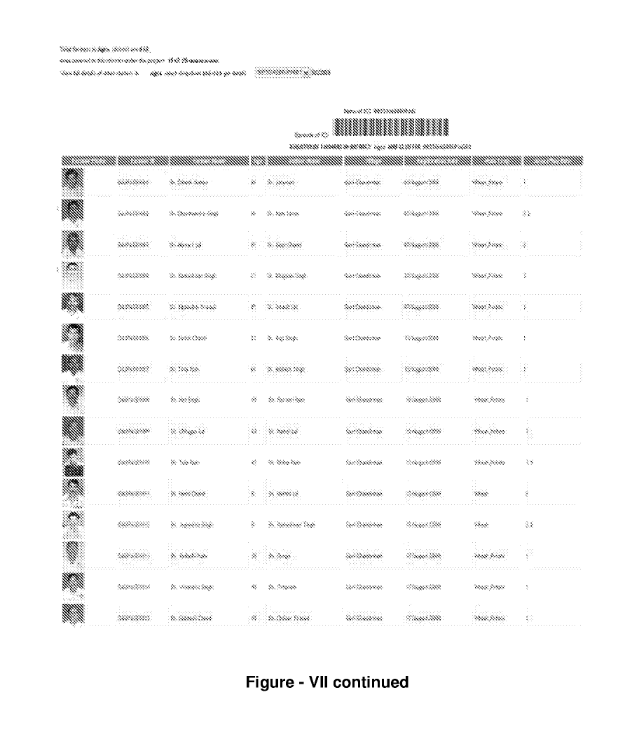

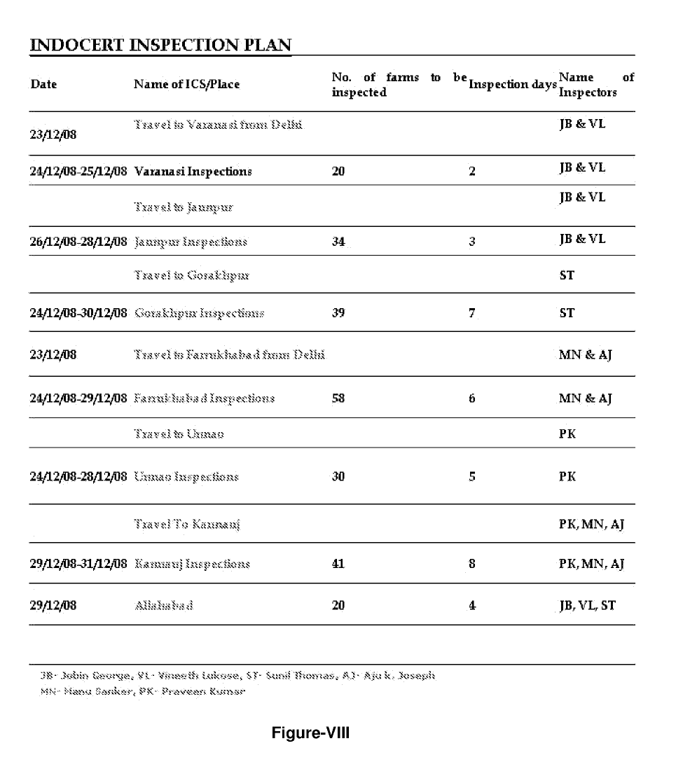

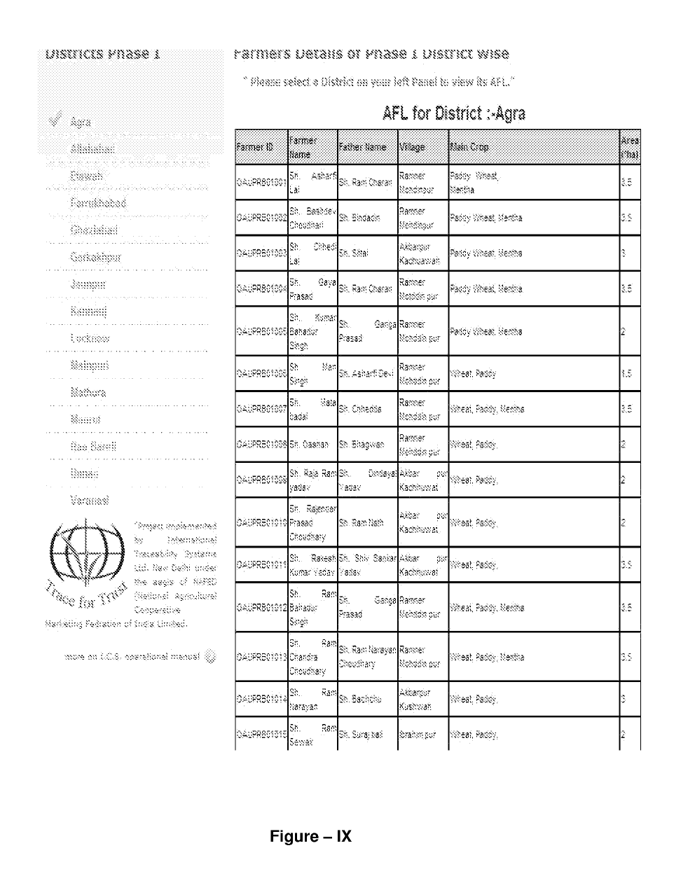

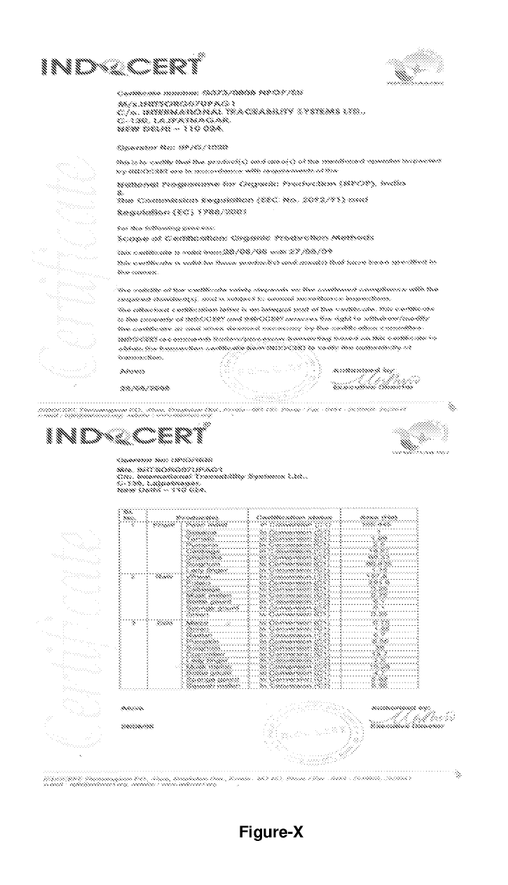

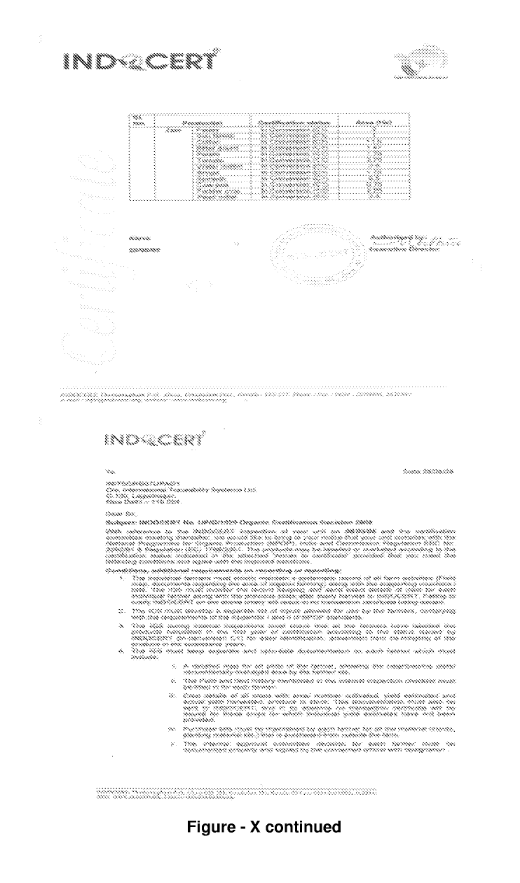

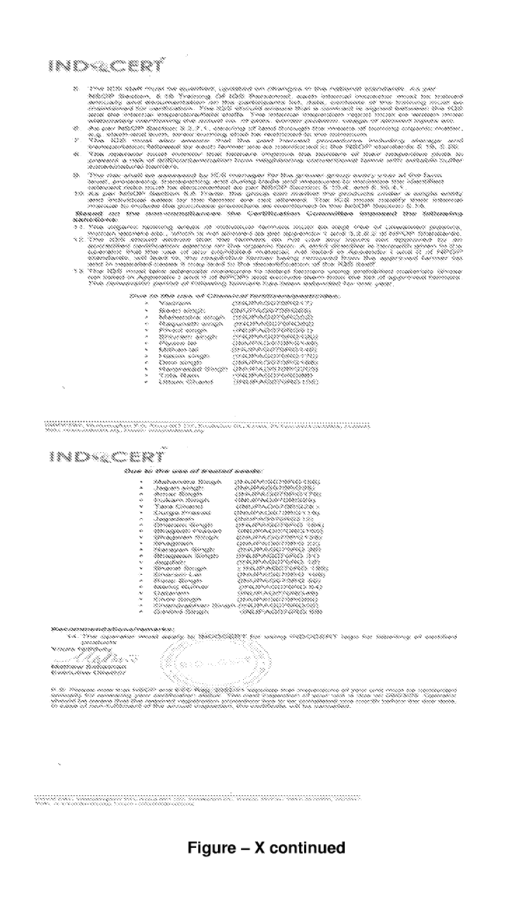

### FIELD OF THE INVENTION

The present invention relates to a process of electronic management of organic production and certification on cluster basis to facilitate high quality services required for organic compliance of both internal control system and external inspection and certification at single or multiple geographic regions or areas.

### BACKGROUND OF THE INVENTION

One essential aspect of certified organic food production is the necessity of using inputs that are certified organic, such as fertilizers, which are either approved, such as materials containing no pathogens or other disqualifying components, or regulated and accepted, such as manures, composts and the like that meet the applicable standards. Technology developed to date for producing certified organic fertilizer products has not been satisfactory due to one or more problems in product quality, environmental acceptability or economic feasibility for providing a reasonably priced commercial product.

The U.S. Publication No. 20070163316 discloses high organic matter plant food products for agronomic uses. Also disclosed are combination products comprising the high organic matter plant food products, articles made from and incorporating same and methods of using the same in agricultural operations for restoration and/or maintenance of organic matter values and/or nutrient values in soils, particularly certified organic farm soils; U.S. Publication No. 20070101783 discloses a method for manufacturing a liquid nitrogen fertilizer from organic wastes and manures, in which nitrogen is extracted as an aqueous ammonia, and further concentrated, and eventually converted to nitrate in a biological reactor. The method may utilize nitrogen rich organic wastes and manures, such as wastewater sludge, slaughter house wastes, broiler layer, and guano, and it is especially suitable for providing a nitrogen fertilizer in organic farming; U.S. Publication No. 20080190158 discloses the identification of bio fertilizers as an alternative to chemical fertilization to increase soil fertility and crop production using sustainable farming. Treatment is with at least a proprietary formulation of a nitrogen-fixing consortium and Azospirillum brasilense. The application of bio fertilizers resulted in higher biomass compared to chemical fertilizer treatment. Chlorophyll and nitrogen levels in these grass plants are also likely to be improved.

With the concern of food security, the nutritional quality of the food and safety of the process through which the food is produced have gained momentum widely around the world, particularly large scale contamination of food chain and water through pesticide residues, a reduction in nutrient and flavor content, dry matter and important minerals, and anti-oxidant micro nutrients.

There has been increasing demand for the food which has been safely produced and quality of the produce for health benefits of the people. The food produced based on the standard organic production procedure is devoid of the use of synthetic fertilizers, chemical pesticides and also use of hormones. Further, in order to see that the organic food is produced following an acceptable standard and passing through a standard certification procedure, facilitating the producer to the consumer that a standard process of production has been followed and also ensuring the consumer about the quality of the produce and safety management. The safety management includes several established procedures including production of the inputs to be used for organic farming, the whole range of Internal Control System (ICS) including the implementation of electronic-traceability (e-traceability) and organic standards, on line documentation, internal inspection and finally external inspection and certification.

It is apparent from the above that there is a substantial unmet need for environmentally and economically acceptable technologies for production of organic fertilizer and soil builder products that can be certified for food production inputs under established standards for certified organic food production. The present invention is directed to methods, systems and products for meeting one or all of these needs.

It is an aim of the present invention to provide the process of electronic management of organic production and certification in the light of the objects of the invention, including knowledge based implementation of organic standards, cluster based production and certification, electronic mode of implementation of different standards and certification system, with ultimate aim of increasing ecological production and maintaining organic integrity, producing high-quality food fulfilling human and environmental health.

Therefore, it is apparent there is a need for an effective and economically viable solution to the problems of organic production and certification. The products and methods of this invention provide solutions to these problems.

### OBJECT OF THE INVENTION

The principal object of this invention is to operationalize a process of electronic management of organic production and certification

Another object of this invention is to provide an electronic method of monitoring a cluster of organic producers instead of individual organic producer to improve the technological feasibility and economic viability of organic production and certification.

The object of this invention is on-farm input management through online record of soil health, status and standardization of ‘in soil culture’ at single and multiple locations, improving location specificity of on-farm input management.

A further object of this invention relates to a process of electronic mode of implementation of Internal Control System (ICS) through online record of Farm Diary (Daily Activities) and establishment of a reliable traceability systems to indicate the origin/mode of production of agricultural products with a view to provide a direct linkage between crop production practices of the farmers in one hand and the requirement of internal inspection and external inspection for certification on the other.

Still another object of the present invention relates to outcome of the process is increasing ecological production and maintaining organic integrity, producing high-quality food fulfilling human and environmental health.

### SUMMARY OF THE INVENTION

In one aspect of the present invention a method for electronically manage organic information includes requesting credentials information like organic production, geographical indications from applicants in a plurality of formats, collecting received credentials information from the applicants in a common format through an interface to a global network, storing collected credentials information in a dynamic database and verifying collected credentials information with external sources through an electronic interface.

### BRIEF DESCRIPTION OF DRAWINGS

These and other features and advantages provided by the present inventions will become better and more completely understood by studying the following detailed description of presently preferred example embodiments in conjunction with the drawings, of which:

FIG. I illustrates the flow chart of the operational model of the process of electronic management of organic production and certification right from the Formation of Cluster of Farmers after their identification and registration to External Inspection and Certification.

FIG. II indicates an exemplary Farmers' Details including farmers ID, date of registration and cropping system of Cluster I of Agra district of Uttar Pradesh.

FIG. III shows exemplary details of on line soil reporting system of Cluster I of farmers in Allahabad district of Uttar Pradesh.

FIG. IV shows exemplary details of supply of ‘In soil culture’ as per the target in different districts and cumulative achievements.

FIG. V shows exemplary details of farmer soil health and ID-Card. Besides the personal details of a farmer each card contains 15 Digit ID Number and status of the availability of major plant nutrients besides pH and conductivity. The card further contains the information on fertility status of the soil based on its characterization of different parameters including specific problem of acidity/alkalinity.

FIG. VI indicates exemplary details of daily activities maintained in the form of Farm Diary to facilitate the implementation of Internal Control System. The Farm Diary is therefore is an authentication of an entire agriculture operation, details of inputs used and sources including the seeds and planting material and the estimation of expected yield.

FIG. VII indicates an exemplary detail of Internal Control System (ICS) with ICS code and ICS name in different districts. The ICS code is represented by a Bar Code through which both the geographical traceability and the production traceability can be established. This Code is essentially the representation of ICS name comprising of 14-Digit, where 2-Digit for India, 3-Digit for International Traceability System, 3-Digit for Organic Agriculture, 2-Digit for the year of implementation which is 2008, 2-Digit for the State Uttar Pradesh, 2-Digit for the different Districts of Uttar Pradesh.

FIG. VIII shows an exemplary inspection plan of INDOCERT (Indian Organic Certification Agency) for final approval on decision for organic certification.

FIG. IX shows an exemplary Approved Farmers' List (AFL) prepared and submitted to certification body like Indian office of Socie'te' Ge'ne'rale de Surveillance (SGS) located at Gurgaon (Haryana) and Indian Organic Certification Agency (INDOCERT), Cochin (Kerala) for approval.

FIG. X indicates exemplary details of certificate issued by INDOCERT in accordance with the requirements of the National Programme for Organic Production (NPOP), India and The Commission Regulation (EEC No. 2092/91) and Regulation (EC) 1788/2001. The certificate also includes the farmers not recommended for Organic Certification and the reasons for such non-certification due to use of certain inputs not approved for organic production.

### DETAILED DESCRIPTION OF THE INVENTION

“Organic Agriculture is a holistic production management system which promotes and enhances agro-ecosystem health, including biodiversity, biological cycles and soil biological activities. It emphasizes on the use of on-farm input management practices in preference to the use of off-farm inputs, taking into account that regional conditions require locally adapted system. This is accomplished by using, where possible, agronomic, biological and mechanical methods, as opposed to using synthetic materials to fulfill any specific function within the system” (Codex Alimentarious Commission, June, 1999). An organic level indicates to the consumer that a product was produced using certain production method. In other words, organic is a process claim rather than a product claim (FAO Committee on Agriculture, 15^{th} Session, 25-29 Jan. 1999).

The present invention relates to the introduction of the concept of organic farming, training of farmers on organic food production, convert conventional farms into organic agriculture production farms, promote on farm inputs management, conservation of soil health, making production, marketing and distribution system e-traceable, compliance to organic standards as per international requirements, certification of project areas by accredited certification agency acceptable in most world countries, safe food production and quality assurance, introduce e-organic agriculture management systems, and making organic farming in India comparable and competitive in world market. The major crops included are wheat, paddy, arhar (pigeon pea), green gram, black gram, bengal gram, lentil, mustard, sesame, groundnut, sunflower, maize, bajra (pearl millet) and jowar (sorghum).

There are a number of activities initiated before the actual initiation of the process, which include manpower recruitment and training, and awareness creation on organic farming. The flow chart of the process of electronic management of organic production and certification includes Registration and formation of cluster of farmers, Training of farmers in coordination with State Department of Agriculture, On-farm input management, Implementation of e-traceability and on-line documentation, Setting up of Internal Control System (ICS), Internal inspection, risk assessment and management, Approval of decision, and External inspection and certification (FIG. I).

1. Registration and Formation of Clusters of Farmers

Each cluster is formed of 50 hectare, to facilitate easy adoption of organic practices by the farmers in one hand and management of the project as well as marketing of organic produce on the other. The information each of farmer in a cluster is recorded which include personal details, description of land, and details of cropping systems. All the farmers in each cluster are required to sign an agreement to abide by the organic production regulations including those related to various inspections.

2. Imparting Training

Both orientation and refresher trainings are provided by experts to all the resource persons on various aspects of organic farming including appropriate crop rotation, green manuring, compost making, biological pest control method, and mechanical cultivation practices in order to maintain soil productivity and control pests; certification regulations including certificate—1, 2, 3 after the end of each conversion year till three years to assure quality; on farm input management; data recording, etc. The field staffs are provided with Manuals on organic both NPOP (National Programme on Organic Production) to facilitate introduction, purpose, benefits, elements, instructions of organic farming and availability of the organic inputs including fertilization, soil conservation and control of disease and pest; and NSOP (National Standard for Organic Production), the guidelines framed by the Government of India for organic farming and certification; Farm diary to maintain the information about the farmer, crop, day to day activities in the field, harvesting and cost; On-farm input management booklet to provide knowledge for detailed methodology for preparation of compost including NADEP compost, Cow Pat Pit (CPP), vermicompost, vermiwash, etc.; and related Flip charts for easily understanding of farmers about organic farming, benefits of organic farming in clusters, etc. In addition to training provided to each registered farmer during registration on different aspects of organic farming by the field staff, they are regularly updated through demonstrations on input management, organizing organic club meetings and customised trainings. Each registered farmer is also provided with literature on organic farming, on-farm input management, farm diary and National Standard for Organic Production.

3. On-Farm Input Management

As far as on-farm input management is concerned, the soil samples from the farmers' fields are analysed for soil pH, Electric conductivity, and status of major plant nutrients like Nitrogen, Phosphorus and Potash. Based on the soil test reports the farmers are issued with Soil Health and ID Cards. The soil samples are also collected from the farmers' fields for different growing seasons for different crops for isolation and characterization of micro organisms through microbial profiling in collaboration with Indian Institute of Technology (IIT), Delhi, which is used for preparation of ‘In soil culture’, a formulation of high density microbial consortium, for distribution back to individual farmers as per the guidelines provided under IFOAM (International Federation of Organic Agriculture Movements). The ‘In soil culture’ improves the bio-degradability of organic matter thereby increases the load of beneficial microbes and reconditions the soil by solubilising soil minerals and increasing its uptake in the plant, reducing the chemical and metabolic toxicity of soil, enhancing the process of bio-degradation and increase in soil organic content, soil conditioning and balancing of soil pH, increasing soil nutrient contents, increasing the local beneficial soil microbial population, and increasing plant immunity system.

Each registered farmer as a part of organic production planning prepares NADEP compost unit, a method of composting developed by Shri Pandhari Pande from Maharashtra, India. NADEP composting is a way to recycle agricultural wastes rapidly to produce good quality compost in a pit raised above ground with perforated walls to allow air circulation facilitating aerobic decomposition of organic matter.

Cow Pat Pit (CPP) refers to a process of preparation of a specialized type of compost by mixing cow manure with crushed eggshell and basalt dust in appropriate proportion, which is fermented in an underground pit to make nutrient rich compost. CPP is used as ground spray, soil inoculant, foliar feed, liquid manure and also for treatment of seeds, seedlings and cuttings before sowing/planting.

4. Implementation of E-Traceability and On-Line Documentation

Traceability is the ability to trace and follow a food, feed, food-producing animal or substance intended to be or expected to be incorporated into a food or feed in all stages of production, processing or distribution. Traceability answers the question “Where did my product come from?” The e-traceability system is developed to provide a direct linkage between crop production practices of the farmers and the regulatory agencies verifying the authenticity of food. A multi-tiered electronic information system was developed for communication both within the project and for external use of the regulatory bodies including certification. The process of e-traceability provides a cost effective method for determining the geographical and production origin of agricultural products. The information about the day to day activities taken up by all the registered farmers in the fields are collected as per the prescribed format by the Cluster In-charges on monthly basis and further uploaded in the website. Such database system provides details of Registration Number of farmers, seeds and planting material used, irrigation and fertilizer schedule and harvesting information.

5. Setting Up of Internal Control System (ICS)

Internal Control System (ICS) is set up for internal inspection and group certification in project area. One ICS Unit is formed in each district and training is provided to each person operating ICS system. The ICS activities include orientation program to motivate the farmers, risk assessment, helping farmers in data recording in farm diary, and training cum review meeting for the field staff.

Each registered farmer is given a Barcode based on a 14-Digit number, consisting of first two digits for the country i.e. India, and subsequently, three digits indicating the name of the company i.e. International Traceability System. Further digits indicate, in order as, Organic Agriculture, Year of Implementation, Name of the State i.e. Uttar Pradesh, and Name of the District.

6. Risk Assessment and Its Management

Risks that may affect organic quality must be known and taken into account in all internal procedures. Some major risks are drift and leaching of chemicals from the neighboring inorganic fields, problems of maintaining buffer/border crop in the field, intensity of use of inorganic/chemical inputs in the area including seeds and planting materials, mixing of organic and inorganic produce, storage of organic and inorganic produce together, storing of organic and inorganic inputs together, and use of shared agriculture equipments by organic and non-organic farmers. Based on initial risk assessment covering all the issues by the internal control system, all necessary measures are taken to minimize the risks.

7. Internal Inspection

Internal inspection is conducted twice in a year for all the registered farmers. Based on the overall risk assessment at the time of internal inspection the minimum re-inspection rate is determined and critical control points are identified. On the basis of the internal inspection report of the farmers who comply with National standard for Organic Production (NSOP), the final list of the farmers is prepared.

8. Approval of Decision

There is an Approval Committee for making final approval decision after thorough checking of internal inspection report. On the basis of this decision, Approved Farmers' List (AFL) is prepared and submitted to certification body like Indian office of Socie'te' Ge'ne'rale de Surveillance (SGS) located at Gurgaon (Haryana) and Indian Organic Certification Agency (INDOCERT), Cochin (Kerala) for approval.

9. External Inspection and Certification

External inspection is done on the farmers' fields, storage places, and also the conversion period once in a year by the certification body. Conversion period of organic production is the time between the start of organic management and the time of certification of the production procedure as organic. On the basis of the report of external inspection, the certificates are provided as Certificate-1 (C-1) by the end of First year of conversion period, Certificate-2 (C-2) by the end of Second year, and finally, Certificate-3 (C-3) by the end of Third year for complete conversion.

While the inventions have been described in connection with what is presently considered to be the most practical and preferred embodiment, it is to be understood that the inventions are not to be limited to the disclosed embodiment, but on the contrary, are intended to cover various modifications and equivalent arrangements included within the spirit and scope of the appended claims.

### SCOPE AND/OR AMBIT OF THE INVENTION

1. This invention helps to improve the implementability of traceability system because e-traceability provides information regarding details of the farmers, registration and farm, planting material used, irrigation and fertilizer schedule followed and harvesting in an easiest way and strengthening the overall agricultural information system.
2. This invention provides knowledge to cluster of organic producers instead of individual organic producer to improve the technological feasibility and economic viability of the process of organic production and certification.
3. This invention provides on-farm input demonstrations, training and organic compliance manual to provide more practical knowledge to the farmers.
4. This invention provides in ‘In soil culture’ for enrichment of compost and to increase the fertility of soil.
5. This invention provides e-traceability system which is the easiest way to record day to day activities of farmers in their field and this information helps to keep update the website.
6. This invention creates internal Control System (ICS) which performs internal inspection to remove the biasness from adjoining areas.
7. This invention helps in risk assessment as well as management with the help of internal inspection.
8. This invention provides certificate to the organic producers as a proof of high quality food fulfilling human and environmental health.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined.

1-10. (canceled)

11. A process for electronic management of organic production and certification comprising of:
a) registering farmers and land clusters;
b) imparting training;
c) managing on-farm input;
d) implementing of traceability and on-line documentation;
e) setting up of Internal Control System (ICS);
f) managing internal inspection and risk assessment;
g) approving of decision; and
h) external inspection and certification.

12. The process for electronic management of organic production as claimed in claim 11, comprising registering at least one detail of personal information, land information, planting information, growing information, harvesting information and other similar information capable of generating and storing in univocal identifying (ID) codes.

13. The process for electronic management of organic production as claimed in claim 11, said land clusters further comprising of grouping of agricultural land with a minimum area of 50 hectare.

14. The process for electronic management of organic production as claimed in claim 11, said imparting training on various aspects of organic farming including appropriate crop rotation, green manuring, compost making, biological pest controlling, mechanical and on similar activities, cultivation practices in order to maintain soil productivity, and controlling of pests.

15. The process for electronic management of organic production as claimed in claim 11, wherein said on-farm input management is about managing fertilizer, pesticide, seeds and other similar inputs.

16. The process for electronic management of organic production as claimed in claim 11, implementing a traceability system with the ability to trace and follow a source of food, feed, and substance intended to be or expected to be incorporated into a food or feed in all stages of production, processing or distribution.

17. The process for electronic management of organic production as claimed in claim 11, wherein said Internal Control System for maintaining quality in operations by regular internal inspection and group certification in the project area.

18. The process for electronic management of organic production as claimed in claim 11, wherein said managing internal inspection and risk assessment is for maintaining organic quality in all internal and external procedures; and provides support in said internal control system.

19. The process for electronic management of organic production as claimed in claim 11, wherein said final approval decision of quality after thorough checking of internal inspection report for in compliance with organic standards of recognized body.

20. The process for electronic management of organic production as claimed in claim 11, wherein said external inspection and group certification in project area for grading operation quality in all internal and external procedures and providing certificates of quality from an external source such as a governmental or governmental recognized body.

21. The process for electronic management of organic production as claimed in claim 12, further comprising of at least one of the personal information in particular about owners' name, age, sex or other similar personal information.

22. The process for electronic management of organic production as claimed in claim 12, further comprising of at least one of the land information about area, location, topographical elevations of the land, embankments, contours, water courses, roads, ditches, utilities, erosion control plan, visible bodies of water, minimum fences, number of walls, number of hedges, amount of drainage, kinds of drainage, level of fertility, percentage of organicatter, pH, biological health, legume content, weed content and other similar land related information.

23. The process for electronic management of organic production as claimed in claim 12, wherein said planting information about previous crop, conditions of plantation, time of plantation, interval between the plantations, distance between two crops, distance between the rows and similar planting information.

24. The process for electronic management of organic production as claimed in claim 12, wherein said growing information about the climate, types of fertilizers used, frequency of fertilizers used, drainage, organic matter in the soil, moisture content in the soil, leaves length, shoot length, root length, nodal length, intermodal length and similar growing information.

25. The process for electronic management of organic production as claimed in claim 12 wherein said harvesting information time of harvesting, equipment or machinery used for harvesting, temperature, moisture and similar harvesting information.

26. The process for electronic management of organic production as claimed in claim 18, further comprising of recording the process and results of said e-traceability system for online documentation in a specified server.

27. The process for electronic management of organic production as claimed in claim 20, wherein said external inspection provided on the farmers' fields, storage places, by the governmental authorized certification body at least once a year.
